(19) United States
(12) Patent Application Publication
(10) Pub. No.: US 2009/0195729 A1
(43) Pub. Date: Aug. 6, 2009

(54) DISPLAY HAVING INTEGRATED FUNCTIONS IN ONE OR MORE LAYERS

(75) Inventors: Michael J. Little, Garden Valley, CA (US); Charles W. McLaughlin, San Anselmo, CA (US)

Correspondence Address: JOSHUA D. ISENBERG;JDI PATENT, 809 CORPORATE WAY, FREMONT, CA, 94539, US

(73) Assignee: AGOURA TECHNOLOGIES, INC., El Dorado Hills, CA (US)

(21) Appl. No.: 12/413,442

(22) Filed: Mar. 27, 2009

(30) Foreign Application Priority Data
Sep. 25, 2007 (US) PCT/US2007/079458

(51) Int. Cl. G02F 1/13357; B29D 11/00

(52) U.S. Cl. 349/64; 349/65; 264/1.34

(57) ABSTRACT

An optical display having integrated functions in one or more layer is disclosed. Specifically, the optical display having two or more of the optical components integrated into a single layer without laminating two different layers of material together. A method of making a wire grids polarizer is also disclosed.

### CROSS REFERENCE TO A RELATED APPLICATION

This application claims the benefit of priority of U.S. Patent Application 60/827,642, which was filed on Sep. 29, 2006, the entire disclosures of which are incorporated herein by reference.

This application claims the benefit of priority of International Patent Application PCT/US2007/079458, which was filed on Sep. 25, 2007, the entire disclosures of which are incorporated herein by reference.

### FIELD OF THE INVENTION

This invention relates generally to optical displays. More particularly, it relates to multi-layer direct view liquid crystal displays.

### BACKGROUND OF THE INVENTION

Liquid crystal displays (e.g., direct-view type) are often made using sandwiches consisting of several layers. For example, FIG. 1 is a schematic diagram illustrating a structure of a direct view display 100. As shown in FIG. 1, display 100 includes a reflector A, a light source B and a diffuser C. The light source B may be a LED with a wedge coupler, a single florescent tube with a wedge coupler or multiple horizontal florescent tubes without a wedge coupler. The display 100 may also include a polarization recovery film C, e.g., 3M's Dual Brightness Enhancing Film (DBEF), a brightness enhancement film (BEF), e.g., prismatic film, two polarizers F and H, a liquid crystal (LC) module G and an anti-reflection layer I. The LC module G may be an active matrix or a passive matrix.

FIG. 2 is an exploded view depicting an example of an LCD display 200 that might be found in a typical small form factor (e.g., 2″×2″ in size) display such as one used in a cell phone. The display is generally divided into a backlight module 202 and an LCD panel 216. As shown in FIG. 2, the back light module 202 includes a light source 201, a wedge light pipe 206 with a diffuse reflector 204 on a back surface thereof. The light source 201 may include a lamp such as fluorescent tube or one or more light emitting diodes (LEDs), and a curved, e.g., lenticular reflector that collects and distributes the light from the lamp. A bottom diffuser 208 may be disposed between a front surface of the wedge light pipe 206 and a prism film 210. The prism film 210 is disposed between the bottom diffuser 208 and a combined layer 212 incorporating a top diffuser 214 with a polarization recovery function, e.g., a wire-grid polarizer.

The LCD panel 216 includes a bottom polarizer 218 proximate a bottom mother glass 220 and top polarizer 230 proximate a top mother glass 228. A thin film transistor (TFT) array 222, a liquid crystal 224 and a color filter 226 is disposed between bottom mother glass 220 and top mother glass 228.

The various components of such displays are typically manufactured by stacking or laminating two separately manufactured layers together to form a single layer. For example, a laminated film sold under the name Vikuiti™ Dual Brightness Enhancement Film (DBEF) is available from 3M of Saint Paul, Minn., is used as a polarization recycling film (PRF) in prior art displays. DBEF is a multilayer laminated plastic film with alternating layers of isotropic and anisotropic materials. By adjusting the thicknesses of both types of layers one can obtain a strong reflection of one plane of polarization. Such DBEF films have been laminated to diffuser films to produce a single laminated film that combines diffusion and polarization recycling functions.

However, there are several drawbacks to using such laminated films in liquid crystal displays. First, the manufacturing and laminating of multiple layers adds to the complexity and cost of the display. Second, each laminated layer potentially introduces an interface with a surface of a different refractive index. The differing indices can lead to optical loss due to reflection of light at the interface. Third, the use of multiple layers adds to the overall thickness and weight of the flat pane display which is especially a problem in mobile applications. Fourth, since no process works perfectly, laminating two components together entails a yield loss and therefore results in a higher cost. Furthermore, a multiple layer laminated structure presents multiple points of potential de-lamination which adversely affect both yield and reliability.

Therefore, there is a need in the art for liquid crystal display components that combine two or more functions while avoiding lamination of two or more layers.

### BRIEF DESCRIPTION OF THE DRAWINGS

FIG. 1 is a schematic diagram of a direct view of a conventional liquid crystal display.

FIG. 2 is an exploded view schematic diagram of a conventional liquid crystal display.

FIGS. 3A-3D are side view schematic diagrams of portions of direct-view display devices according to embodiments of the present invention.

FIGS. 4A-4F are side view schematic diagrams of backlight modules for direct-view display devices according to embodiments of the present invention.

FIGS. 5A-5F show side view and plan view schematic diagrams of a light guide according to an embodiment of the present invention.

FIGS. 6A-6D are a sequence of side-view schematic diagrams illustrating fabrication of a wire-grid polarizer for a direct view display according to embodiments of the present invention.

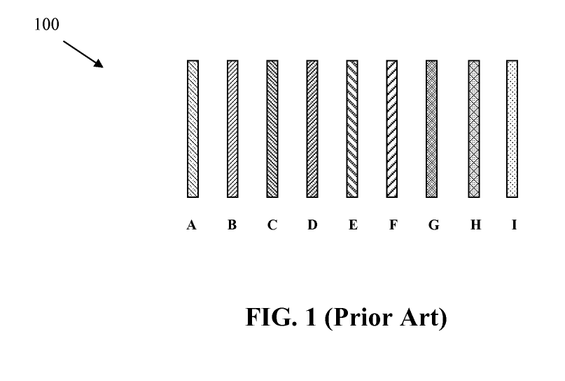

### DETAILED DESCRIPTION

Embodiments of the present invention combine into a single, composite film or molded part, two or more of the above-described functions of a direct view display. Different combinations of direct view display sub-layer functions may be integrated into a single layer or structure without having to laminate two or more separately manufactured layers together. As used herein laminating two layers together refers to the process of joining two superposed layers through the use of an adhesive disposed between the two layers, compressive force applied to the layers, heating of the two layers or some combination of two or more of these. As such, embodiments of the present invention are not limited to the examples described below.

Additionally, some layers in the display assembly must be separated by an air gap because the surface contains topographical structures that perform a needed optical function. Examples of this are the prism surfaces used to control the directionality of the light emanating from the backlight. Ordinarily these surfaces cannot be laminated since they require an air interface. This needed air gap is disadvantageous in many applications where it is very important to minimize the thickness of the display assembly.

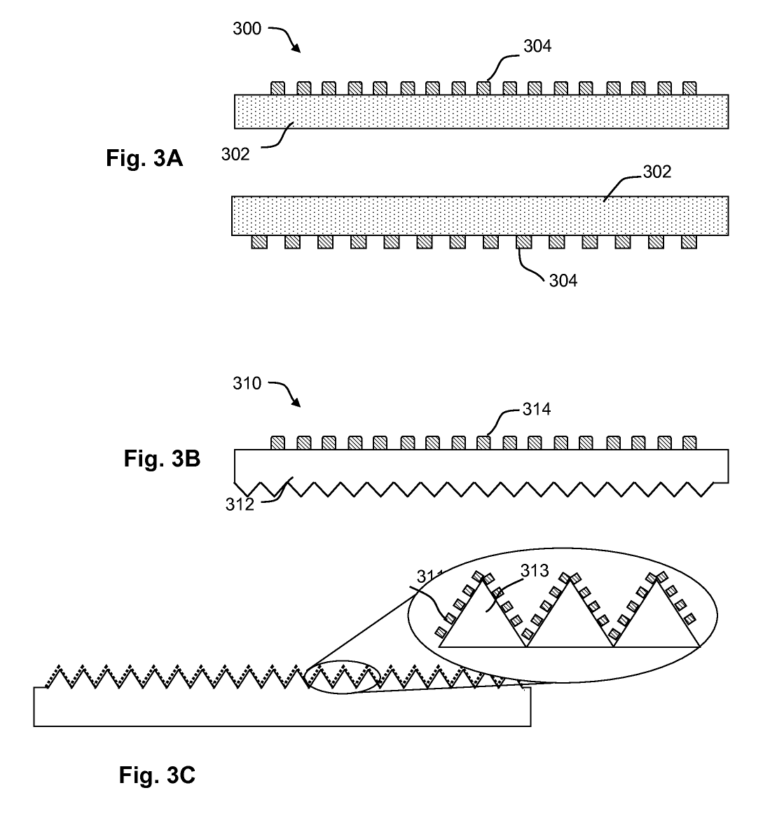

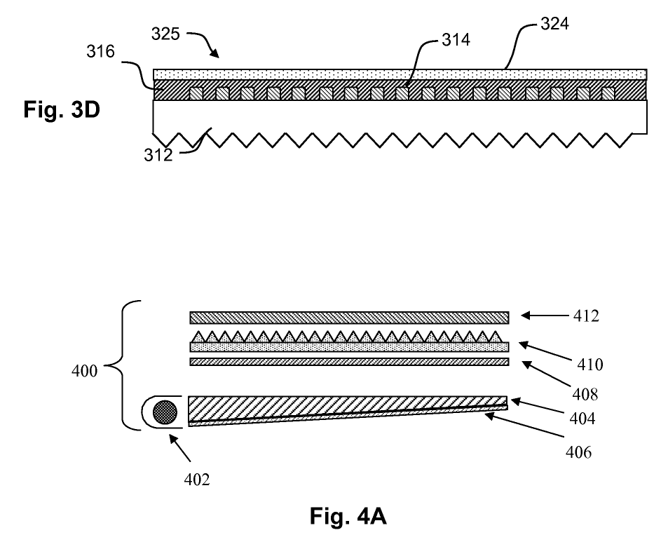

According to an embodiment of the present invention, as shown in FIG. 3A, a single film 300 integrates the diffuser and polarization recovery function. By way of example, a conventional diffuser film 302 may include a very thin surface layer (<1 μm) that acts as a wire grid polarizer 304. The wire-grid polarizer 304 may be fabricated directly on the diffuser film 302, e.g., by embossing the surface of the diffuser with nanometer scale features that would be subsequently subjected to oblique evaporation with a metal to form a wire grid polarizer as described below. Typical diffuser films include a range of polyester films manufactured by SKC Inc of Covington, Ga., Keiwa Inc of Osaka Japan, Tsujiden Co., Ltd of Tokyo, Japan, and Kimoto Tech, Inc of Cedartown, Georgia. By way of example the diffuser film may be a 100SKE from Kimoto Tech, Inc or a CH27 film from SKC Inc.

According to another embodiment of the invention, a single film 310 that integrates a prism structure layer for brightness enhancement and a polarization recovery function. For example, as shown in FIG. 3B, a conventional prismatic reflector film may be coated on the planar side of the prism film 312 with a very thin layer (<1 μm) that functions as a wire-grid polarizer 314. The prism shaped features are typically a few tens of microns in height and lateral dimension while a wire grid polarizer has features in the range of 100 nm (e.g., periodicity of 130 nm and height of 50-100 nm). The wire-grid polarizer 314 may be fabricated on the prism film 312, e.g., as described below. A typical prismatic film is 3M's family of Vikuiti™ Brightness Enhancement Film (BEF) products, for example BEFII 90/50 from 3M of Saint Paul, Minn.

According to another embodiment of the invention, the prism film 312 may include prismatic structures 313 at one surface. A wire grid polarizer 311 may be formed on faces of prismatic structures 313 as shown in FIG. 3C. In the example shown in FIG. 3C the wires in the wire grid polarizer 311 and the prismatic structures 313 run parallel to each other in a direction perpendicular to a plane of the drawing. However, the wires in the wire grid polarizer 311 and prismatic structures 313 may alternatively be oriented non-parallel to each other, e.g., orthogonal or non-orthogonal to each other.

Certain advantages of wire-grid polarizers in direct view displays and some techniques for manufacturing them by embossing and oblique evaporation with metal are described, e.g., in US Patent Application Publication number US2006/0118514, to Michael J. Little and Charles W. McLaughlin, entitled APPLICATIONS AND FABRICATION TECHNIQUES FOR LARGE SCALE WIRE GRID POLARIZERS which was published on Jun. 8, 2006 and filed on Nov. 28, 2005, the entire disclosures of which are incorporated herein by reference.

FIG. 3D depicts a variation on the structures of FIGS. 3B and 3C, which combines prism structure with a wire grid polarizer as a polarization recycling film, a prismatic film and a diffuser layer.

In FIG. 3D, a combined film 325 includes a prism structure film 312 with a wire-grid polarizer 314 incorporated into a planar side of the prism structure film 312, e.g., using a contouring and oblique deposition process as described below. A planarizing material 316 having a low index of refraction fills in the spaces between metal lines in the wire grid polarizer 314 and provides a planar surface for forming a diffuser layer 324, which may be formed, e.g. by an imprinting or molding process to create scattering surface structures in the diffuser layer 324. Alternatively, a planarizing diffuser layer may be vapor deposited over the wire grid polarizer 314. Or a layer of a light scattering material may be coated onto the top surface.

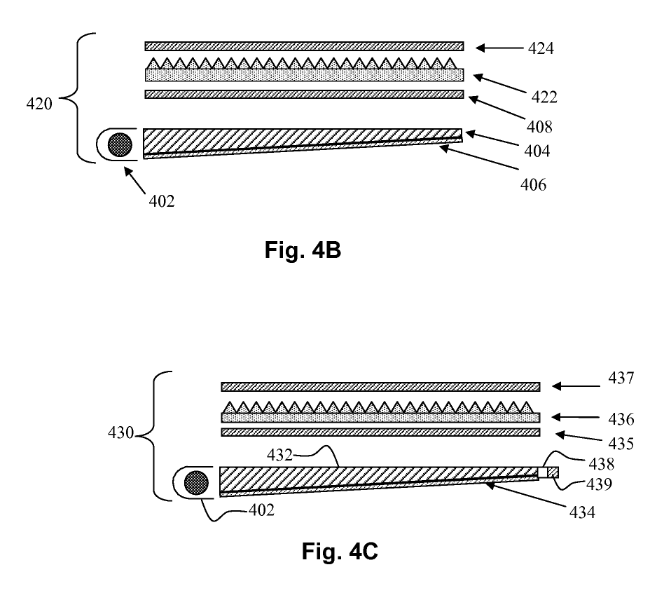

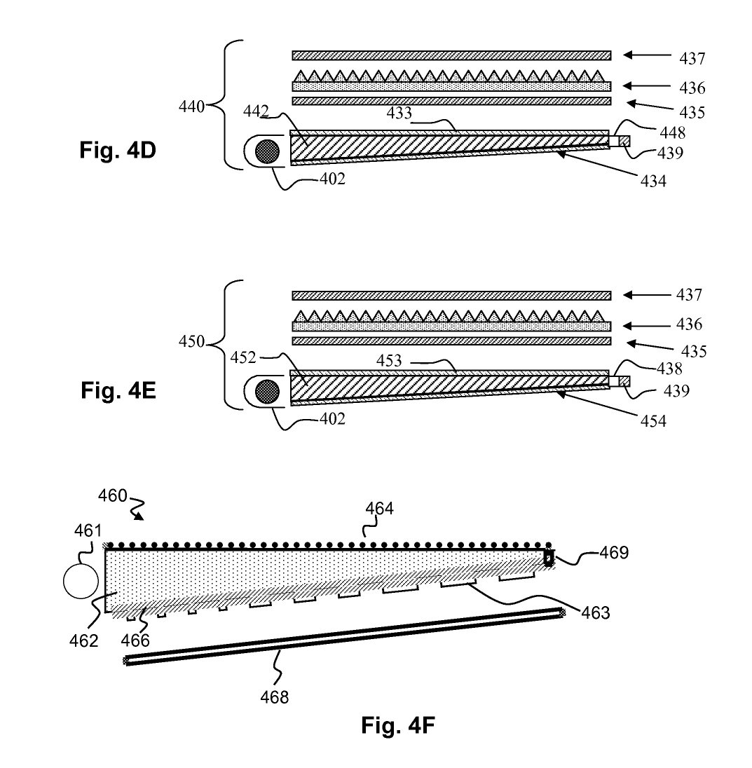

Various improvements of the types depicted in FIGS. 3A-3D may be incorporated into the backlight module of a liquid crystal display. According to another embodiment of the present invention, a single (molded) wedge or planar light guide component may be capable of (a) mounting and holding the light source (LED or florescent tube); (b) acting as a coupler including a reflector that collects and distributes the light from the light sources; (c) integrating a down diffuser function; (d) integrating a polarization recovery function; and (e) integrating a brightness enhancement function. For example as shown in FIG. 4A, a backlight module 400 may include a light source 402, a wedge light pipe 404 with a diffuse reflector 406 on a back surface thereof. The light source 402 may include a lamp, such as fluorescent tube or one or more light emitting diodes (LEDs), and a curved, e.g., lenticular reflector that collects and distributes the light from the lamp. A bottom diffuser 408 may be disposed between a front surface of the wedge light pipe 404 and a prism film 410. The prism film 410 is disposed between the bottom diffuser 408 and a combined layer 412 incorporating a top diffuser with a polarization recovery function, e.g., a wire-grid polarizer. By way of example, the combined layer 412 may be fabricated as described above with respect to FIG. 3A with the wire grid polarizer 304 disposed between the prism film 410 and the diffuser layer 302. Alternatively, as shown in FIG. 4B, a backlight module 420 may incorporate the brightness enhancement and polarization recovery functions into a single combined layer 422 disposed between a lower diffusion layer 408 and a top diffusion layer 424. The combined layer 422 may be of the type shown in FIG. 3B.

In the combination shown in FIG. 4B the wire grid polarizer may be below the prism film in the combined layer 422. Generally, wire grid polarizers have a wider acceptance angle than 3M's DBEF (which begins to show chromatic effects if the light bundle contains a significant amount of off-axis rays). The difference between putting the polarization recycling film above the prism film as opposed to below the prism film is that above the prism film, there are fewer off-axis rays than below the prism film. A wire grid polarizer below the prism film is expected to be acceptable due to the larger angle of acceptance of the wire grid polarizer.

Additional enhancements of the back light module may be obtained by combining a polarization recycling function into one or more surfaces of the wedge light pipe 404, e.g., as shown in FIGS. 4C-4E. The backlight module 430 of FIG. 4C includes a light source 402 coupled to a wedge or planar light pipe 432 having a polarization recycling film 434 incorporated into its back surface, a bottom diffuser 435, a prism film 436 and a combined layer 437 that incorporates a top diffuser and polarization recycling function. By way of example, the polarization recycling/diffuser film 437 may include a wire grid polarizer. The polarization recycling film 434 makes the light emerging from the light pipe 432 much richer in one plane of polarization than the other and the polarization recycling function is accomplished within the light guide. A reflector 439 and a ¼ wave plate 438 may be optically coupled to an edge of the light pipe 432 opposite the light source 402 to recycle the unused plane of polarization.

FIG. 4D illustrates a backlight module 440 that is a variation on the one depicted in FIG. 4C. The backlight module 440 includes light pipe 442 having polarization recycling films 433,434 on its front and back surfaces respectively. It is desirable for the polarization recycling films 433, 434 to have perpendicular polarizing directions with respect to each other. For example, if wire grid polarizers are used for the polarization recycling films 433 and 444, the lower recycling film 434 may have wire features that run perpendicular to the plane of the drawing while the upper recycling film 433 has wire features that run parallel to the plane of the drawing. Such wire grid polarizers may be incorporated into the light pipe 442 through a combination of injection molding to produce rippled surfaces on the front and back sides of the light pipe combined with oblique evaporation of metal onto the rippled surfaces.

An additional embodiment would be to apodize the wire grid polarizer structure on the backlight modules 430, 440 by not having it continuous across the back side. In some planar light guides, dots of white paint of varying density and size are added to the backside to get uniform intensity across the full face of the light guide. A similar effect may be accomplished by breaking the wire grid polarizer into small segments of varying size and density

FIG. 4E depicts another variation of this concept. In FIG. 4E a backlight module 450 includes a light pipe 452 having a polarization recover film 453 formed on its front surface and a plane reflector 454 formed on its back surface, e.g., by metal vapor deposition.

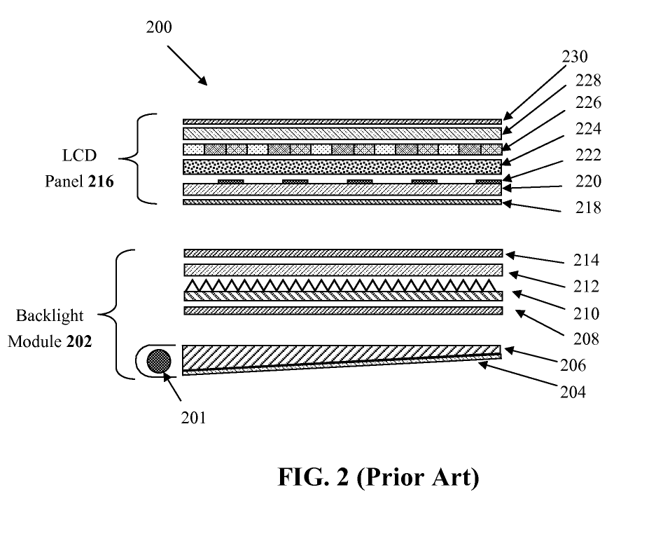

FIG. 4F shows a fully integrated light-guide 460 that could be used in a mobile application such as a cell phone. The light-guide 460 includes a wedge shaped light pipe 462 with a front surface 464 that incorporates microlenses and/or a nanometer-scale feature diffuser. A back surface of the light pipe 462 may include reflective dots 463 with micrometer or nanometer scale features. The architecture of the light guide 460 may be similar to the current architecture, e.g., as shown in FIG. 2. However the proposed design not only includes many or all of the functions of the conventional backlight stack but additionally the assembly delivers polarized light to the LCD (polarization film is not shown in FIG. 2 but could be added as an additional layer on top of the optical element stack or could be a design element of the nanostructures embossed on the back side of the wedge. In FIG. 4F a nano structure wire grid polarizer 466 is incorporated into the back side of the light-pipe 462 between the light pipe 462 and a reflector 468. In such a case, a majority of the light from a source 461 that is scattered out of the light-guide 460 towards the display may be richer in the desired plane of polarization and the undesired plane of polarization is propagated towards the thin end of the wedge where a layer 469 (e.g., a quarter waveplate reflector) is included (or added) that rotates the plane of polarization by 90 degrees such that the light reflected back towards the source is now richer in the desired plane of polarization. This thereby accomplishes the polarization recycling function by keeping the undesired plane of polarization within the wedge until it has the correct polarization before sending it to the display.

Like the conventional design, embodiments of the present invention may use an array of reflective dots on the back of the backlight to uniformly distribute the emitted light in the plane of the display. Furthermore a conventional reflector may reflect any light emitted from the back of the light-guide back into the light pipe.

However the reflective dots are unique in that they incorporate both micro and nano optical features that are molded into the surface of the light guide. The micro features create a micro grid pattern that redirects the light incident on the dots at a grazing angle in the direction normal to the plane of the display. Furthermore, the nano grid features on the surface of the micro array features reflect light of a preferred polarization and the other polarization of light for recycling. The combination of the micro level optical features and the nano scale wire grid polarizer grid features integrate three functions:
1. The spacing and size of the micro features evenly distribute the light in the plane of the display.
2. The micro scale optical features redirect the light, incident at a glancing angle in a direction normal to the display surface.
3. The WGP nano features reflect only the preferred polarization of incident light and transmit the other polarization within the light pipe where it is recycled by virtue of reflection and a quarter wave reflector at the small end of the light guide wedge.

The top surface of the light guide may also include a combination nano and micro patterned layer. A molded microlens array collimates the light in the normal direction. In addition, a light scattering nano scale diffuser layer may be incorporated into the top surface.

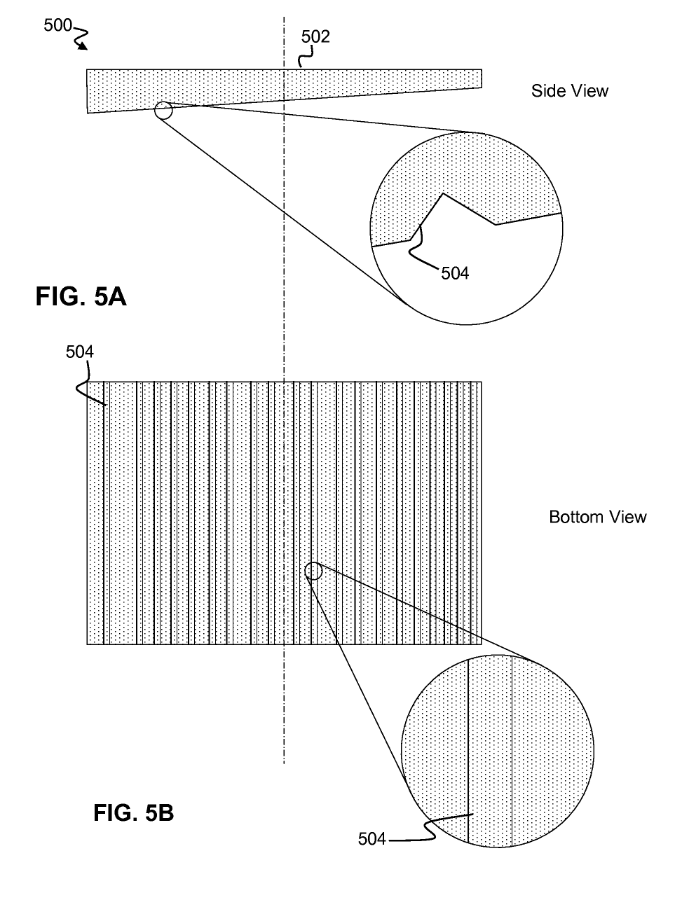

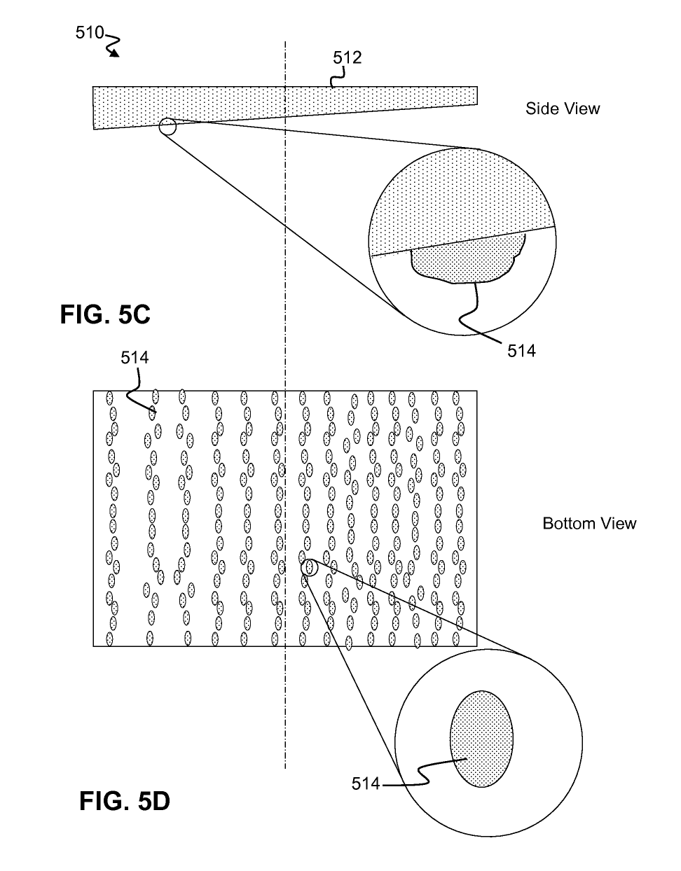

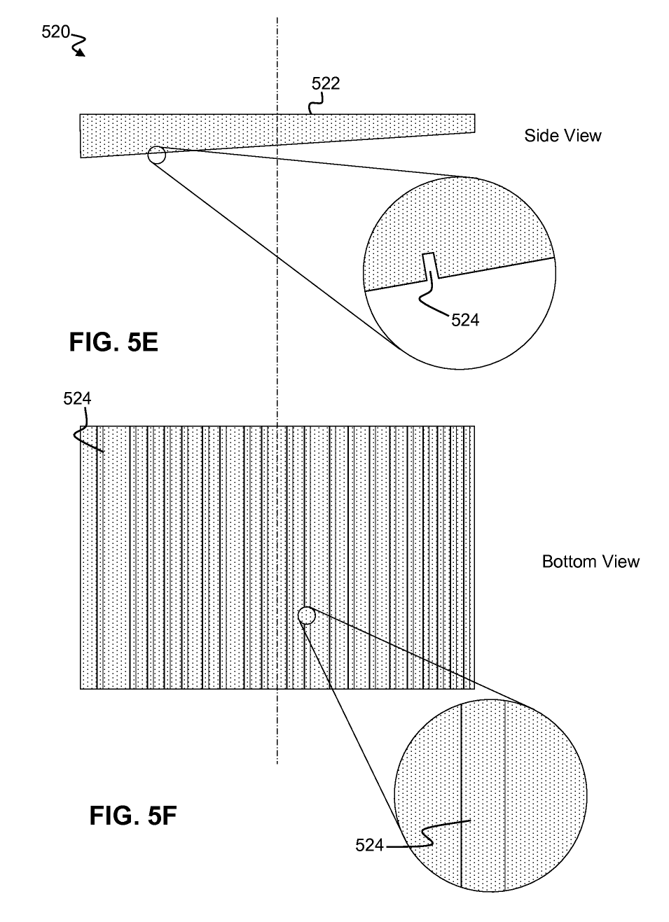

There are a number of different possible configurations for combinations of nanometer scale features with micron scale features that can be molded into the surface of the light guide. For example, FIGS. 5A-5B are side view and bottom view of a light guide 500 in the form of an optically transmissive prismatic wedge 502 having a series of micron scale triangular lenticular grooves 504 formed into one side. The grooves 504 have density (number of grooves per unit length) that increases with distances from the thicker end of the wedge 502.

FIGS. 5C-5D are side view and bottom view of a light guide 510 in the form of an optically transmissive wedge 512 having nanometer scale dots 514 of a light scattering material formed onto one side. The dots 514 have density (area of dot per unit area of the lightguide) that increases with distances from the thicker end of the wedge. The dots may vary in density across the width of the wedge 512 in a pattern that compensates for non-uniformity in the intensity of light along the width of the wedge 512, e.g., due to the use of multiple light emitting diodes as opposed to a single fluorescent bar as a primary light source.

FIGS. 5E-5F are side view and bottom view of a light guide 520 in the form of an optically internal scattering wedge 522 having a series of nanometer rectangular grooves 524 formed into one side. The grooves have density (number of grooves per unit length) that increases with distances from the thicker end of the wedge.

To facilitate integration of wire-grid polarizers into various layers of a direct-view display, embodiments of the invention include various methods for making wire-grid polarizers. For example, a wire-grid polarizer may be fabricated by molding or embossing a polymer material such as polycarbonate (PC) or polyethylene terephthelate (PET) with a rigid master insert having more or less parallel structures at a line width of e.g., 50 nm and a pitch of, e.g., 130 nm. Subsequently metal may be obliquely evaporated over the structures leaving metal coating one side of the structures and absent from the other side of the structures thus forming the series of metal lines of the wire grid polarizer.

The use of oblique evaporation in combination with either UV or thermal molding is particularly advantageous if the shape of the structure has sharply pointed external corners (e.g., apex angle less than 90°) and obtuse internal corners (e.g., interior angles greater than 90°). During the molding process, the polymer is deformed and forced to flow into the recessed features of the mold. However, viscosity opposes the flow of the polymer into the vertex of corners if they are not obtuse. Thus, square-cornered shapes require more time (or elevated temperatures to lower the viscosity of the polymer) making them more expensive and difficult to mold than a sharply peaked shape. Also, if the structure to be molded is flat-topped and square-cornered one tends to get a constant thickness on the flat surface of the feature. With a sharply peaked feature, greater control over thickness variation in the evaporated metal is possible. Thus molded peaked features provides better thickness control and lower cost.

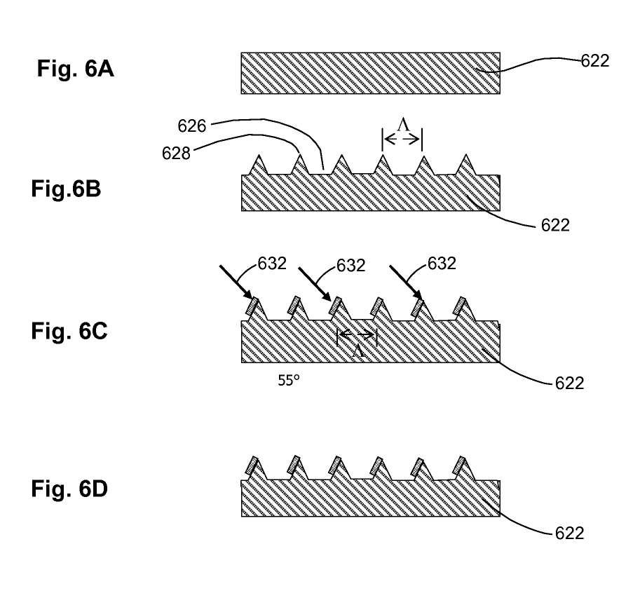

The basic technique used with the immediately preceding embodiment is illustrated in FIGS. 6A-6D. First a suitable substrate 622, e.g., polycarbonate or PET, is provided as shown in FIG. 6A. Then, as shown in FIG. 6B, a series of valleys 626 and ridges 628 are formed on the substrate, e.g., by injection molding, embossing, stamping or imprint lithography. The valleys 626 have obtuse angles and ridges 628 are sharply peaked. The periodicity Λ of the structures is significantly smaller than a wavelength λ of interst, e.g., less than about one third of λ. By way of example the periodicity Λ may be between about 10 nm and about 500 nm, preferably, about 130 nm or less. Next, as shown in FIG. 6C, metal 632 is deposited over the valleys 626 and ridges 628 at an oblique angle, for example about 55°. The oblique evaporation deposits metal on one side of the ridges 628 while the other side remains uncoated. The completed structure, as shown in FIG. 6D, has many desirable features for wire grid polarizers. The fraction of each period that is covered by metal can be readily controlled. If high contrast is desirable and low transmission of the wire grid polarizer is not as important, the fraction of the period covered by metal can be large. In some applications it is advantageous to have high transmission while high contrast is less important; in this application a small fraction of the period can be covered with metal.

Large area wire grid polarizers can be fabricated with this embodiment with a step and repeat process. Again, peaked structures are preferred in order to provide greater latitude in the controlling the metallized fraction of each period Using a step and repeat process to form large area wire grid polarizers naturally entails joints that may not have optical performance (e.g., contrasr and transmission) as high as that within an individual step field. By putting the step and repeat wire-grid polarizer directly on a diffuser similar to one that would ordinarily be included in an LCD assembly, one can tune the step and repeat process and the diffusion level (optical scattering) to optimize the performance to remove artifacts associated with the joint features between adjacent fields of the wire-grid pattern. If enough light is scattered across the “street” between adjacent blocks the artifacts will not be visible. This embodiment enables a simplification of the LCD assembly but eliminating a separate layer of the display structure, thereby reducing optical loss due to reflections and reducing cost.

In some embodiments, a “prism” or corner cube reflector, prism-type brightness enhancer or diffuser may be molded in the same step that is used to form the ridges and valleys for the wire grid polarizer. The “pyramid or corner cube reflectors may be macro-scale features having dimensions in the range of 10s of microns. Such features are relatively easy to form with molding. At present these prisms structures are embossed in this embodiment, structures necessary for fabricating the wire grid polarizer would be embossed simultaneously on the opposite side to result in a combined functionality component. This combined functionality component would eliminate a separate layer from the LCD assembly and thereby reduce size, improve performance and reduce costs.

It will be clear to one skilled in the art that the above embodiments may be altered in many ways without departing from the scope of the invention.

While the above includes a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A direct-view display, comprising two or more of the following components:
a reflector; a light source; a light guide, a diffuser; a polarization recovery layer; a first polarizer; a brightness enhancement film; an image generating module; a second polarizer; and an anti-reflection layer,
wherein two or more of the components are integrated into a single layer without laminating two different layers of material together.

2. The display of claim 1 wherein a single film integrates a diffuser and polarization recovery function.

3. The display of claim 2 wherein a conventional diffuser film includes a surface layer that acts as a wire grid polarizer.

4. The display of claim 1 wherein a single film integrates a brightness enhancement and polarization recovery function.

5. The display of claim 4 wherein a prism film is coated on the planar side of the film with a layer that functions as a wire-grid polarizer.

6. The display of claim 4 wherein a prism film is coated on the prism side of the film with a layer that functions as a wire-grid polarizer.

7. The display of claim 6 wherein the prism film includes prismatic structures, wherein a wire grid polarizer is formed on faces of the prismatic structures.

8. The display of claim 7 wherein the wire grid polarizer includes wires oriented parallel to the prismatic structures.

9. The display of claim 1 wherein a single (molded) component is capable of (a) mounting and holding the light source; (b) acting as a coupling light guide including the back reflector that collects and distributes the light from the light sources; (c) integrating two or more of the following functions: a diffuser function; (d) integrating a polarization recovery function; and (e) integrating a brightness enhancement function.

10. The display of claim 9 wherein the light guide includes a diffuse reflector incorporated into a back surface thereof.

11. The display of claim 9 wherein the light guide includes a polarization recovery function incorporated into a back surface thereof.

12. The display of claim 11 wherein the polarization recovery function includes a wire grid polarizer.

13. The display of claim 9 wherein the light guide includes polarization recovery functions incorporated into front and back surfaces thereof.

14. The display of claim 13 wherein the polarization recovery functions have orthogonal polarization directions with respect to each other.

15. The display of claim 14 wherein the polarization recovery functions include wire grid polarizers.

16. The display of claim 9 wherein the light guide includes a polarization recovery function incorporated into a front surface thereof and a reflector incorporated into a back surface thereof.

17. The display of claim 16 wherein the polarization recovery function includes a wire grid polarizer.

18. The display of claim 1 wherein a single film incorporates a brightness enhancement function, a polarization recovery function and a diffuser function.

19. The display of claim 18 wherein the single film includes a prismatic brightness enhancement film, a wire grid polarizer formed on a planar surface of the prismatic brightness enhancement film and a layer of diffuser material formed over the wire grid polarizer.

20. A method for making a wire grid polarizer, comprising:
forming a plurality of ridges and valleys characterized by a periodicity that is significantly less than a wavelength of interest;
obliquely depositing metal over the ridges and valleys such that the metal is coated at least partially on one side of the ridges and not on the other side.

21. The method of claim 20 wherein forming a plurality of ridges and valleys includes injection molding thermal embossing and UV embossing.

22. The method of claim 20 wherein forming a pluarlity of ridges and valleys includes imprint lithography.

23. The method of claim 19 wherein the ridges are characterized by a peaked profile.
